(19) United States
(12) Patent Application Publication
(10) Pub. No.: US 2012/0325076 A1
(43) Pub. Date: Dec. 27, 2012

(54) Composite Armor

(76) Inventor: Stephen A. Monette, JR., New Bedford, MA (US)

(21) Appl. No.: 13/167,154

(22) Filed: Jun. 23, 2011

(51) Int. Cl. F41H 7/02; B32B 37/14; F41H 5/04; B32B 37/12

(52) U.S. Cl. 89/36.02; 156/60; 89/910; 89/917; 89/930; 89/914

(57) ABSTRACT

Ultra high hardness steel based composite armor having crack mitigating layers. A method of using ultra high hardness steel in ballistics armor applications. A method of overcoming brittleness of a ultra high hardness steel plate for using the ultra high hardness steel in ballistic armor applications.

### BACKGROUND OF THE INVENTION

1. Field of the Invention

The present invention relates generally to armor. More particularly, the present invention relates to an ultra high hardness steel-based composite armor.

2. Description of Related Art

It is well known that steel, titanium and aluminum alloys are primary metallic materials used for bullet resistant armor applications due to their low cost, ease of fabrication, available supply chain and performance characteristics. However, it is also well known that these metallic solutions exhibit characteristics such as high specific gravity and a requirement to use significant thicknesses of material to meet modern threats such as armor piercing projectiles and or improvised explosive devices. The increased weight seen with metallic armor solutions creates problems with extreme wear and tear on vehicles, increased fuel consumption and large on-going maintenance costs. Additionally, vehicle weight limitations may prevent adequate thickness of metallic armor being used due to the high weight characteristics of said materials.

To counter the issue of weight seen with traditional metallic solutions, ceramic composite armor solutions utilizing ceramics such as alumina oxide, silicon carbide or boron carbide, aramid, fiberglass or polyethylene or any combination thereof have been developed and deployed. However, ceramic composite solutions have cost limitations that prevent industry wide usage. These cost limitations are directly attributed to high cost of raw materials, significant energy costs required to manufacture these ceramic materials, significant engineering time to integrate onto a vehicle platform, inherent brittleness of ceramics on the battlefield along with reduced protection at strategic locations such as triple points (where 3 ceramic tiles form a seam/joint) and ceramic tile seams (where 2 ceramic tiles form a seam/joint). Triple points and seams create a particular issue because ceramic composite armor solutions are fabricated in small pieces (approx 4″ square at most). Therefore the number of seams and triple points is very high when the ceramic armor is in operation on an armored vehicle, airplane or the like.

Therefore, what is needed is a high performance armor solution that is low cost, effective, and lightweight.

### SUMMARY OF THE INVENTION

The subject matter of this application may involve, in some cases, interrelated products, alternative solutions to a particular problem, and/or a plurality of different uses of a single system or article.

In one aspect, an ultra high hardness steel based composite armor is provided. The armor comprises an ultra high hardness steel plate having an outer face and an inner face, a first crack mitigating layer disposed on the outer face, a second crack mitigating layer disposed on the inner face, wherein the outer face is constructed and arranged to receive an impact of a ballistic projectile, and wherein the first and second crack mitigating layers are constructed and arranged to prevent a crack in the ultra high hardness steel plate from forming and spreading.

In another aspect, a method of using ultra high hardness steel in ballistic armor applications is provided. The method comprises the steps of selecting a suitable ultra high hardness steel layer, selecting a suitable material to serve as a crack mitigating layer, adding a resin to the material selected as the crack mitigating layer to reinforce the crack mitigating layer, curing the resin, bonding the crack mitigating layer to the ultra high hardness steel layer using an adhesive, thereby forming an ultra high hardness steel based composite ballistics armor, and mounting the armor to a vehicle.

In yet another aspect, a method of overcoming a brittleness of a plate of ultra high hardness steel for using the plate in a ballistic armor application is provided. The method comprises the steps of selecting a first ultra high hardness steel plate to act as a strike face to receive an impact from a ballistic projectile, selecting a suitable material to act as a crack mitigating layer, the crack mitigating layer constructed and arranged to reinforce the ultra high hardness steel to prevent a crack from spreading, preparing the crack mitigating layer for bonding to the ultra high hardness steel plate, wherein the first ultra high hardness steel plate has a Rockwell Hardness C value greater than 55, wherein the suitable material is selected based on having similar material properties as the ultra high hardness steel plate, and wherein the step of preparing the crack mitigating layer comprises impregnating a resin throughout the material; curing the resin; and bonding the material to a first side of the ultra high hard steel plate and a second side of the ultra high hard steel plate.

### BRIEF DESCRIPTION OF THE DRAWINGS

FIG. 1 provides an embodiment of the UHH steel composite armor.

FIG. 2 provides another embodiment of the UHH steel composite armor when mounted to a vehicle.

FIG. 3 provides another embodiment of the UHH steel composite armor.

FIG. 4 provides another embodiment of the UHH steel composite armor.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention is directed to a composite armor based on ultra high hardness steel (hereinafter referred to as UHH steel). The composite armor may comprise a UHH steel plate layer, a crack-mitigating and encapsulation layer on both sides of the UHH steel layer, and a plurality of additional supporting or reinforcing ballistic resistant layers. The composite armor contemplated herein may be deployed on vehicles such as land vehicles, trucks, armored personnel carriers, tanks, airplanes, and the like. Further, scaled-down versions of the present invention may be deployed for personal use as heavy body armor, shields, blast shields, and the like.

The term “ultra high hardness steel” (UHH steel) is defined for the purposes of the entirety of this document to refer to a specific type of steel. The UHH steel having a composition that, when properly treated, exhibits hardness approximately in the range of Rockwell Hardness C (HRC) 55-70. One drawback caused by the formulation of the ultra high harness of the UHH steel is that it is quite brittle. UHH steel is substantially harder than other hardened steels such as “High Hard” steel, which exhibits an HRC of approximately 51-53, but the high hard steel is not nearly as brittle.

UHH steel having HRC values of approximately 55-70 has been heretofore dismissed as being useful for armor applications. UHH steel, despite having a desirable hardness, has been thought to be too brittle for armor applications. The brittleness is generally so substantial that a UHH steel plate may work once to defeat a projectile, but will be nearly useless after an initial impact because the plate is so heavily cracked or shattered.

The present invention achieves a superior composite armor by utilizing the hardness of the UHH steel to shatter and destroy incoming projectiles. At the same time, the present invention overcomes the problem of brittleness and cracking. The result is a highly effective, low cost and light weight composite armor solution.

The composite armor disclosed herein may have a UHH steel layer. The UHH steel layer may be of any size, thickness, and shape that may be effectively produced, manipulated, and attached to a vehicle, airplane or other device that may be armored. In one embodiment, the UHH steel layer may be a plate approximately 24 inches in width and 24 inches in height. Preferably, the UHH steel layer may be a plate larger than approximately 30 square inches. Further, the UHH steel may be cut, molded and welded as needed to accommodate the shapes of an almost infinite number of different vehicles. In one embodiment, the UHH steel may be pre-formed to fit about a certain vehicle.

In one embodiment, the UHH steel layer may be approximately 0.1875 inch in thickness. In another embodiment, the UHH steel layer may be approximately 0.500 inch in thickness. In still another embodiment, the UHH steel layer may be approximately 0.250 inch thick. In yet another embodiment, the UHH steel layer may vary between 0.1875 inch and 0.500 inch in thickness, depending on the projectiles it is intended to defeat.

The UHH steel may be any steel based alloy having a HRC hardness of approximately 55 to 70. To achieve hardness in this range, the steel may consist of approximately the following elements by weight percentage: 0.43-0.47% carbon, 0.377-1.000% molybdenum, 0.70-1.00% manganese, 0.48-1.5% chromium, and 3% nickel, the balance being iron, and other trace alloying elements which are not critical to the hardness of the UHH steel.

The UHH steel composite armor may have a crack-mitigating layer disposed on the UHH steel layer. In one embodiment, the crack mitigating layer may be disposed on an outer face of the UHH steel plate. In another embodiment, the crack mitigating layer may be disposed on both an inner and an outer face of the UHH steel plate. In yet another embodiment, the crack mitigating layer may be disposed about all surfaces of the UHH steel plate.

The crack-mitigating layer may be any fibrous material capable of being securely disposed on each face of the UHH steel plate that may mitigate cracking of the UHH steel upon a projectile impact. In one embodiment, the crack mitigating layer is composed of a high modulus fiber. In another embodiment, the crack mitigating layer may be a high modulus fiber that has similar material properties to the UHH steel plate, including similar yield strength, tensile strength, and elongation. In one embodiment, the crack mitigating layer may be carbon-fiber. In another embodiment, the crack mitigating layer may be fiberglass. In yet another embodiment, the crack-mitigating layer may be an aramid, including para-aramids and meta-aramids. Further embodiments of crack-mitigating fibrous materials may include nylon, ceramic fibers, and polyethylene, among others.

A resin may be incorporated, or impregnated, into the fibrous material to reinforce the crack mitigating layer. The resin may be any resin capable of incorporation into the fibrous material and capable of curing into a solid state. Examples of suitable resins include but are not limited to epoxy resin, polyester resin, vinylester resin, and the like. The resin may be cured in any manner known in the art including room temperature curing, heat curing, curing under vacuum, or any combination thereof.

Because of the unique properties of the UHH steel of the present invention, the curing of the resin may be performed at a low temperature. Preferably, the temperature may not exceed approximately 250-300 Fahrenheit.

The crack mitigating layer may be disposed on the UHH steel plate in any manner that allows secure attachment to the plate. Once the crack mitigating layer is disposed on the UHH steel plate, the structure formed is a UHH steel composite armor.

In one embodiment, an adhesive may be used to dispose the crack mitigating layer on the UHH steel plate. In a further embodiment, the resin may be used as the adhesive as well as reinforcement for the crack mitigating layer. In another embodiment, the crack mitigating layer may be tightly drawn across the UHH steel plate and attached on an outside edge of the plate. In yet another embodiment, the crack mitigating layer may be mechanically disposed on the UHH steel plate by mechanical attachment such as screws, bolts, rivets, and the like.

In a further embodiment, a plurality of crack mitigating layers may be disposed on the UHH steel plate.

The present invention may use the UHH steel composite armor as a strike face, which is the surface designed to receive a direct impact from an incoming projectile. In further embodiments, additional projectile defeating layers may be employed to reinforce the armor by catching ballistic fragments and/or absorbing impact forces of an incoming projectile. The additional layers may include additional layers of UHH steel composite armor as well.

In one embodiment, one or a plurality of para-aramid layers such as Kevlar® may be attached to an inner side of the UHH steel composite armor. In this embodiment, the outer surface of the UHH steel composite armor may act as a strike face. In this configuration, the para-aramid layer may capture any fragments of the projectile that may pass through the strike face. The number of layers of para-aramid attached may vary depending on the type of projectile intended to be defeated.

In another embodiment, a foam metal may be attached to an inner side of the UHH steel composite armor. The outer surface of the UHH steel composite armor may serve as a strike face. In this configuration, the foam metal layer may capture any fragments of the projectile that may pass through the strike face. The foam metal may also aid in absorbing an acoustic impulse wave caused by projectile impact. The foam metal may vary in thickness based on the type of projectiles intended to be defeated, along with weight considerations and restrictions.

A plurality of UHH steel composite armor layers may be secured together. In one embodiment, a first layer of UHH steel composite armor may be attached to a second layer of UHH steel composite armor. In another embodiment, a layer of foam metal may be disposed between the two layers, by, for example, being adhesively bonded to an inner surface of the first layer. The density of the foam metal may vary depending on intended usage; however, in one embodiment, the foam metal may have a density of 10%. The first layer of UHH steel composite armor may be a strike face. In one embodiment, the first layer of UHH steel composite armor may be slightly thicker than the second.

The above noted embodiment may be further reinforced by adhesively bonding a layer of aramid fiber on an inner surface of the second layer of UHH steel composite armor. The layer of aramid fiber may be adhesively bonded using any suitable adhesive. In one embodiment, a polyurethane adhesive may be employed. In another embodiment, a silyl modified polymer may be employed.

The multiple layers of UHH steel composite armor may be attached together in any manner capable of securely holding them together. Suitable attachment may be performed using, for example: a polyurethane adhesive, an epoxy adhesive, a silyl modified polymer, the plates may be mechanically connected using bolts, screws, or the like or multiple attachment types may be employed, such as the use of an adhesive in combination with a mechanical attachment.

A method of using UHH steel in ballistic armor applications by overcoming its brittleness is contemplated herein. As noted above, a substantial drawback to the use of UHH steel in ballistic armor applications is its brittleness. This brittleness leads to cracking and/or shattering of the UHH steel upon projectile impact. The shattering severely limits the effectiveness of the armor after a first impact. The method herein comprises the application of a crack-mitigating composition to a first side and a second side of a UHH steel plate to overcome the brittleness of the UHH steel.

The method disclosed herein may comprise the steps of selecting a suitable UHH steel layer, selecting a suitable material for a crack mitigating layer, adding a resin to reinforce the crack mitigating layer, curing the resin of the crack mitigating layer, bonding the crack mitigating layer to a first side and a second side of a UHH steel plate, thereby creating a composite ballistics armor, and mounting the composite ballistics armor to a vehicle.

The step of selecting a suitable UHH steel layer may be performed by identifying, ordering and/or receiving a quantity of steel with qualities of UHH steel. Suitable UHH steel may have an HRC of approximately 55-70. In one embodiment, the UHH steel layer may have an HRC hardness greater than 60. In another embodiment, the UHH steel layer may have an HRC hardness greater than 65.

The step of selecting a suitable material for the crack mitigating layer may be performed by identifying, ordering, and/or receiving a high modulus fibrous material that has similar material properties to the UHH steel. Suitable materials for the crack mitigating layer include but are not limited to carbon-fiber, fiberglass, aramid fibers, including para-aramids and meta-aramids, nylon, ceramic fibers, and polyethylene, among others.

The step of adding a resin to reinforce the crack mitigating layer may be performed in any manner that allows the fibrous material to be impregnated with the reinforcing resin. In one embodiment, the resin may be pre-impregnated with the fibrous material (commonly referred to as “pre-preg”). In another embodiment, the resin may be sprayed onto the fibrous material. In yet another embodiment, the resin may be painted onto the fibrous material. In still another embodiment, the fibrous material may be soaked in the resin and removed for bonding once saturated with resin. In still another embodiment, a resin may be added to the fibrous material by vacuum assisted resin transfer molding (VARTM).

The step of curing the crack mitigating layer ensures that the resin is properly set and ensures that the crack mitigating layer has the appropriate properties needed to mitigate cracking of the UHH steel plate. In one embodiment, the curing may be done in the open air by air curing. In another embodiment, the crack mitigating layer may be vacuum cured by covering the uncured resin-impregnated fibrous material with an air-tight material such as a plastic film, and drawing a vacuum within the covering. In yet another embodiment, a quantity of heat may be applied to the resin impregnated fibrous material. In still another embodiment, a combination of heat and vacuum may be employed to cure the crack mitigating layer.

The step of bonding the crack mitigating layer to a first side and a second side of the UHH steel plate may be performed in any manner that allows the crack mitigating layer to be securely bonded to the UHH steel. In one embodiment, the resin may act as an adhesive as well as reinforcement, both bonding the fibrous material to itself, and also the UHH steel. In this embodiment, the bonding step may be performed nearly simultaneously with the step of adding a resin. In another embodiment, the crack mitigating layer may be bonded to the first and second side of the UHH steel plate by an adhesive such as a polyurethane adhesive, epoxy adhesive, silyl modified polymer adhesive, and the like. In yet another embodiment, the crack mitigating layer may be mechanically bonded to the UHH steel plate. In still another embodiment, the crack mitigating layer may be tightly drawn across the UHH steel plate.

Once the crack mitigating layer has been properly formed and bonded to the UHH steel plate, it may function as a UHH steel composite armor.

The step of mounting the UHH steel composite armor to a vehicle may be performed in any way such that the armor may be securely and operatively attached to the vehicle. In one embodiment, the UHH steel composite armor may be mechanically mounted on the vehicle by, for example, bolting, nailing, riveting or screwing. In yet another embodiment, the UHH steel composite armor may be pre-formed to a shape of a vehicle, and may act as the body of the vehicle by being mounted to a vehicle frame.

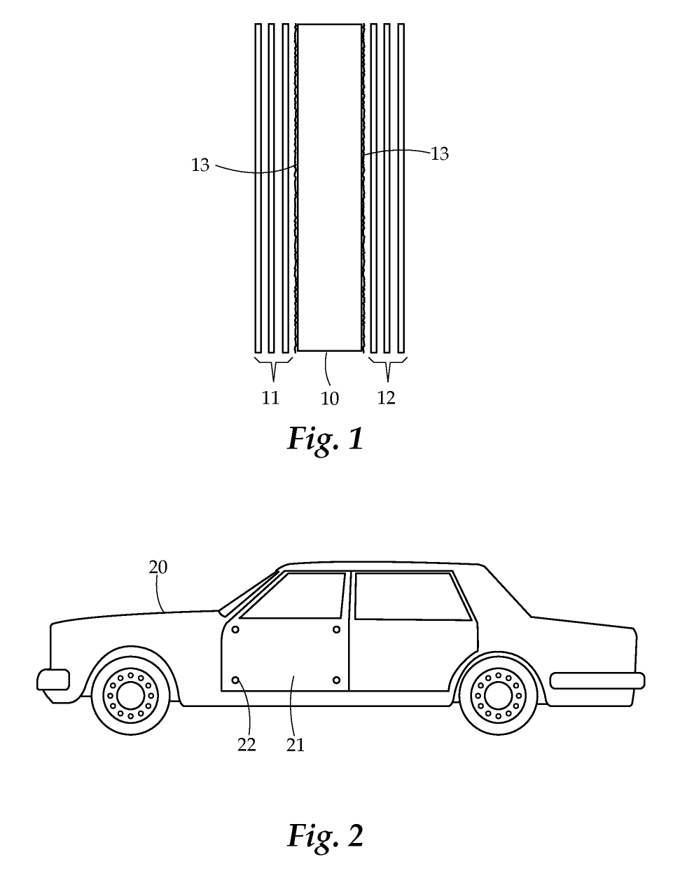

Turning now to FIG. 1, an embodiment of the UHH steel composite armor is shown. A layer of UHH steel 10 has a first crack mitigating layer 11 adhered to an outer face with an adhesive 13. The first crack mitigating layer 11 is shown as three layers, adhered together and to the UHH steel layer 10 using an adhesive 13. The UHH steel layer 10 further has a second crack mitigating layer 12 adhered to an inner face. The second crack mitigating layer 12 is shown as three layers, adhered together and to the UHH steel layer 10 using a resin as an adhesive 13.

FIG. 2 shows another embodiment of the UHH steel composite armor when mounted to a vehicle. The UHH steel composite armor 21 is shown removably mounted to a vehicle 20 by a plurality of bolts 22.

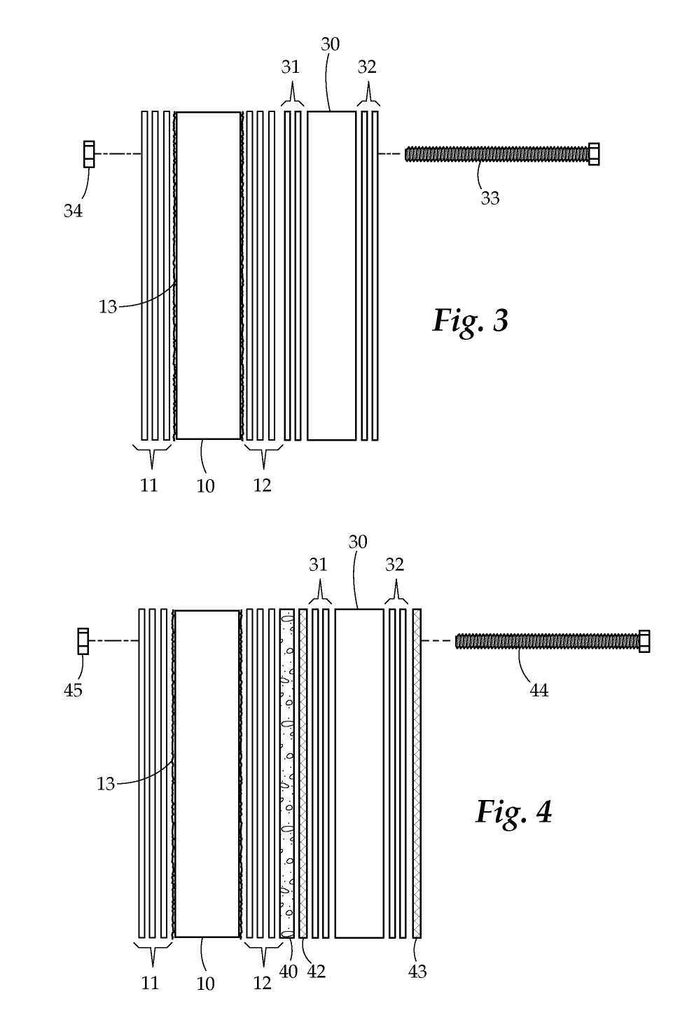

FIG. 3 shows another embodiment of the UHH steel composite armor. A layer of UHH steel 10 has a first crack mitigating layer 11 adhered to an outer face, and a second crack mitigating layer 12 adhered to an inner face by an adhesive 13. A second layer of UHH steel 30 has a first crack mitigating layer 31 adhered to an outer face 31, and a second crack mitigating layer 32 adhered to an inner face. The first layer of UHH steel 10 and the second layer of UHH steel 30 are secured together by a bolt 33 and a nut 34.

FIG. 4 shows another embodiment of the UHH steel composite armor. A layer of UHH steel 10 has a first crack mitigating layer 11 adhered to an outer face, and a second crack mitigating layer 12 adhered to an inner face using an adhesive 13. A second layer of UHH steel 30 has a first crack mitigating layer 31 adhered to an outer face 31, and a second crack mitigating layer 32 adhered to an inner face. A layer of foam metal 40 is disposed between the first layer of UHH steel 10 and the second layer of UHH steel 30. A reinforcing aramid layer 42 is also disposed between the first layer of UHH steel 10 and the second layer of UHH steel 30. A second reinforcing aramid layer 43 is adhered to the inner face of the second UHH steel plate 30. The layers are held together by a bolt 44 and a nut 45.

Exemplary test results of the present invention demonstrate that it may provide the same ballistic protection as expensive and cumbersome ceramic armor.

In one embodiment, a single UHH steel plate having crack-mitigating layers disposed on each side, measuring 24 inches by 24 inches by 0.200 inch is adhesively bonded to a 24 inch by 24 inch by 0.500 inch thick polyethylene laminate. The adhesive bond is achieved with a silyl modified polymer. The plate is shot with a 7.62×52 M61 armor piercing projectile at a zero degree obliquity in a room temperature environment according to Mil STD 662F. The resultant V-50 is 2690 fps.

In comparison, a ceramic composite laminate measuring 24 inches by 24 inches consisting of a plurality of 98% pure 9 millimeter (0.354 inch) thick alumina oxide ceramic tiles is encapsulated with 3 layers of carbon fiber on both front and back surfaces and then is bonded with silyl modified polymer to an aramid laminate consisting of 18 layers of woven aramid fabric constructed from 3000 denier and 17×17 pic count. The plate is shot with a 7.62×52 M61 armor piercing projectile at a zero degree obliquity in a room temperature environment according to Mil STD 662F. The resultant V-50 is 2714 fps.

In another testing embodiment, a composite ballistics armor is designed and manufactured having an “A Kit” and a “B Kit.” The composite ballistics armor is based on the UHH steel contemplated herein. Acting as a strike face is a single UHH steel plate measuring 24 inches by 24 inches by 0.250 inches having 3 layers of carbon fiber pre-impregnated with an epoxy material (hereinafter referred to as “pre-preg”) applied to the front surface of the 0.250 inch UHH steel plate and 3 layers of carbon fiber/epoxy pre-preg material applied to the back surface of the UHH steel plate. A single laminate armor panel consisting of 24 layers of 17×17, 3000 denier aramid is adhesively bonded to the non-strike face side of the “A Kit” using a polyurethane adhesive. A second UHH steel/carbon fiber/epoxy composite is designed and manufactured as a “B Kit”. This is done with a single piece of UHH steel plate measuring 24 inches by 24 inches by 0.290 inches having 3 layers carbon fiber/epoxy prepreg material applied to the front surface of the 0.290 inch UHH steel and 3 layers of carbon fiber/epoxy pre-preg material applied to the back surface of the plate. A single piece of 10 millimeter (0.394 inch) thick aluminum foam with a density of 10% is then bonded to the non-strike face of the “B Kit” armor panel using a polyurethane adhesive. The “A Kit” and the “B Kit” are then mechanically attached. The “B Kit” being the outer layer as the strike face and the “A Kit” being an inner layer behind the “B Kit”. The total areal density of the mechanically attached plates is 26.75 pounds per square foot. The plate is shot with a 20 mm fragment simulating projectile (FSP) at a zero degree obliquity in a room temperature environment according to Mil STD 662F. The resultant V-50 is 4130 fps.

In comparison, a laminate having a ceramic strike face is tested. The strike face layer includes a plurality of Hexoloy Silicon Carbide tiles measuring 4″×4″×0.550″ and the inner layer includes a commercially available 0.250 inch thick High Hard Steel plate that conforms to Mil-Spec 46100D. The total areal density of the mechanically attached plates is 25.25 pounds per square foot. The plate is shot with a 20 mm FSP (fragment simulating projectile) at a zero degree obliquity in a room temperature environment according to Mil STD 662F. The resultant V-50 is 4130 fps. Thus the UHH based composite armor provides equivalent performance to ceramic armor at nearly the same weight, substantially less cost and without the problems associated with ceramic armor.

Further testing of the UHH steel based composite armor in the above embodiment demonstrates results superior to ceramic-based armor when tested against a 0.50 caliber AP M2 projectile at a zero degree obliquity in a room temperature environment according to Mil STD 662F. Under those conditions, the above embodiment yields a resultant V-50 of 3020 fps.

In comparison, the ceramic based armor noted above is tested against a 0.50 cal AP M2 projectile at a zero degree obliquity in a room temperature environment according to Mil STD 662F. The resultant V-50 is 2698 fps.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. An ultra high hardness steel based composite armor comprising:
an ultra high hardness steel layer having an outer face and an inner face;
a first crack mitigating layer disposed on the outer face;
a second crack mitigating layer disposed on the inner face;
wherein the outer face is constructed and arranged to receive an impact of a ballistic projectile; and
wherein the first and second crack mitigating layers are constructed and arranged to prevent a crack in the ultra high hardness steel layer from forming and spreading.

2. The ultra high hardness steel based composite armor of claim 1 wherein the armor is removably mounted to a vehicle.

3. The ultra high hardness steel based composite armor of claim 1 wherein the ultra high hardness steel layer is sized to be larger than 30 square inches.

4. The ultra high hardness steel based composite armor of claim 1 wherein the first crack mitigating layer and the second crack mitigating layer are comprised of carbon fiber cured with a resin, and wherein the resin further acts as an adhesive to dispose the first and second crack mitigating layer on the inner and outer face of the ultra high hardness steel layer.

5. The ultra high hardness steel based composite armor of claim 1 wherein the first and second crack mitigating layers comprise fiberglass cured with a resin.

6. The ultra high hardness steel based composite armor of claim 1 further comprising:
a second ultra high hardness steel layer having an outer face and an inner face;
a first crack mitigating layer disposed on the outer face of the second ultra high hardness steel layer;
a second crack mitigating layer disposed on the inner face of the second ultra high hardness steel layer;
wherein the second ultra high hardness steel layer is secured to the ultra high hardness steel layer with the inner side of the ultra high hardness steel layer facing the outer face of the second ultra high hardness steel layer.

7. The ultra high hardness steel based composite armor of claim 1 further comprising a reinforcement layer attached to the inner face of the ultra high hardness steel layer.

8. The ultra high hardness steel based composite armor of claim 7 wherein the reinforcement layer is a para-aramid fabric.

9. The ultra high hardness steel based composite armor of claim 7 wherein the reinforcement layer is a foam metal.

10. The ultra high hardness steel based composite armor of claim 1 wherein the first and second crack mitigating layer are adhesively bonded to the ultra high hardness steel layer.

11. The ultra high hardness steel based composite armor of claim 2 wherein the ultra high hardness steel layer is molded to accommodate a contour of the vehicle.

12. The ultra high hardness steel based composite armor of claim 2 further comprising:
a bolt aperture formed by the ultra high hardness steel composite armor:
a bolt; and
wherein the bolt aperture is sized to receive and secure the bolt.

13. The ultra high hardness steel based composite armor of claim 1 wherein the ultra high hardness steel layer has a Rockwell Hardness C value of greater than 60.

14. A method of using ultra high hardness steel in ballistics armor applications comprising the steps of:
selecting a suitable ultra high hardness steel layer;
selecting a suitable material to serve as a crack mitigating layer;
adding a resin to the material selected as the crack mitigating layer to reinforce the crack mitigating layer;
curing the resin;
bonding the crack mitigating layer to the ultra high hardness steel layer using an adhesive, thereby forming an ultra high hardness steel based composite ballistics armor; and
mounting the ultra high hardness steel based composite ballistics armor to a vehicle.

15. The method of using ultra high hardness steel in ballistics armor applications of claim 14 wherein the resin is used as the adhesive when bonding the crack mitigating layer to the ultra high hardness steel layer.

16. The method of using ultra high hardness steel in ballistics armor applications of claim 14 wherein the step of bonding the crack mitigating layer to the ultra high hardness steel layer further comprises:
bonding a first crack mitigating layer to an inner side of the ultra high hardness steel layer; and
bonding a second crack mitigating layer to an outer side of the ultra high hardness steel layer.

17. The method of using ultra high hardness steel in ballistics armor applications of claim 14 wherein the step of selecting a suitable ultra high hardness steel layer comprises selecting a steel having a Rockwell Hardness C value greater than 60.

18. The method of using ultra high hardness steel in ballistics armor applications of claim 14 further comprising:
selecting a second suitable ultra high hardness steel layer;
selecting a second suitable material to serve as a crack mitigating layer;
adding a resin to the second material selected as the crack mitigating layer to reinforce the second crack mitigating layer;
curing the resin;
preventing the ultra high hardness steel layer and second ultra high hardness steel layer from reaching a temperature greater than approximately 250 degrees Fahrenheit during the curing step;
bonding the second crack mitigating layer to the second ultra high hardness steel layer using an adhesive, thereby forming a second ultra high hardness steel based composite ballistics armor;
attaching the second ultra high hardness steel based composite ballistics armor to the ultra high hardness steel based composite ballistics armor;
disposing a reinforcing layer between the second ultra high hardness steel based composite ballistics armor and the ultra high hardness steel based composite ballistics armor; and
mounting the armor to a vehicle.

19. A method of overcoming a brittleness of a plate of ultra high hardness steel for using the ultra high hardness steel in ballistic armor applications comprising the steps of:
selecting a first ultra high hardness steel layer to act as a strike face to receive an impact from a ballistic projectile;
selecting a suitable material to act as a crack mitigating layer;
constructing the crack mitigating layer to reinforce the ultra high hardness steel to prevent a crack from spreading;
preparing the crack mitigating layer for bonding to the ultra high hardness steel layer;
wherein the step of selecting the first ultra high hardness steel plate comprises selecting a steel from a group of steels having a Rockwell Hardness C value greater than 60;
wherein the step of selecting the suitable material comprises selecting a material from a group of materials having similar material properties as the ultra high hardness steel layer; and
wherein the step of preparing the crack mitigating layer comprises impregnating a resin throughout the material; curing the resin; and bonding the material to a first side of the ultra high hard steel plate and a second side of the ultra high hard steel plate.

20. The method of overcoming a brittleness of a plate of ultra high hardness steel for using the ultra high hardness steel in ballistic armor applications of claim 19 further comprising:
selecting a second ultra high hardness steel layer;
selecting a suitable material to act as a second crack mitigating layer
preparing the second crack mitigating layer for bonding to the second ultra high hardness steel layer;
attaching the second ultra high hardness steel layer to the first ultra high hardness steel layer; and
disposing a reinforcement layer between the first ultra high hardness steel layer and the second ultra high hardness steel layer.
